(19) United States
(12) Patent Application Publication
(10) Pub. No.: US 2002/0041826 A1
(43) Pub. Date: Apr. 11, 2002

(54) pH test stick

(76) Inventor: Kenji Nakajima, Kitasouma-gun (JP)

Correspondence Address: Kenji Nakajima, 3-19-18, Mizukino, Moriyamati, Kitasouma-gun, JP

(21) Appl. No.: 09/966,151

(22) Filed: Sep. 27, 2001

(30) Foreign Application Priority Data
Oct. 10, 2000 (JP) 2000-308575

(51) Int. Cl. G01N 31/22

(52) U.S. Cl. 422/55; 436/163; 422/56; 422/61

(57) ABSTRACT

The present invention relates to a pH test stick, wherein by partially bonding a pH test paper to a neutral water-repelling mounting paper, a test solution is made to flow into a gap formed between an unbonded separated portion of the pH test paper and the mounting paper to thereby delay drying-out thereof, so that the color tone of the pH test paper developed by the contact with the test solution can be kept for a long time.

### BACKGROUND OF THE INVENTION

1. Field of the Invention

The present invention relates to a pH test stick in which drying-out of a pH test paper is delayed considerably, so that the color tone of the pH test paper lasts long, whose color has been developed due to being damped with a test solution such as water or urine.

2. Description of the Related Art

The pH test paper prepared by having a pH indicator impregnated in a filter paper and dried has an advantage in that a test solution such as water or urine soaks rapidly therein and develops color substantially instantaneously. On the other hand, since the soaked water content intensely evaporates and rapidly dries, there is a fatal defect in that the color tone at the initial stage of color development indicating the correct pH value quickly changes with the advance of drying.

Therefore, at the time of testing using the pH test paper, the pH value must be decided quickly by comparing the color with the colorimetric table within 30 seconds after color development. This requires considerable experience and know-how, and even a veteran who is in charge of the pH test feels nervous. Hence, even if general public who has nothing to do with the pH test tries to test water or urine with the pH test paper, accurate measurement cannot be expected, and in fact, it is no exaggeration to say that it is impossible. Accordingly, as a convenient and accurate pH meter becomes widespread, demands for the pH test paper decrease significantly.

On the other hand, in order to make it possible to perform a pH test easily at home for human urine or urine of pet animals such as dog and cat, there are made popular products such as urinalysis sheets and tissues and cat's toilet beddings produced by mixing quaternary ammonium salt such as alkyltrimethylammonium salt in the pH indicator as a color change inhibitor to be impregnated or printed therein. However, the color change inhibiting effect of quaternary ammonium salt is imperfect, and can maintain the color tone at the initial stage of color development only for about 10 minutes. Therefore, though the pH indicator that can measure the pH value finely is used, the actual situation is such that the urine can only be judged roughly to be acidic, neutral or alkaline.

### OBJECTS AND SUMMARY OF THE INVENTION

It is an object of the present invention to provide a pH test stick that makes it possible to perform pH tests easily at home even by an inexperienced person, by delaying drying-out of the pH test paper, which is a fatal defect thereof, so that the color tone of the pH test paper which has developed color does not change quickly.

That is to say, in the pH test stick of the present invention, by partially bonding the pH test paper to a neutral water-repelling mounting paper, there is formed a gap between the pH test paper and the mounting paper, so that a test solution such as water or urine flows into this gap. In this manner, the isolated portion of the pH test paper where the test paper is not bonded to the mounting paper becomes such that as if it is floating in a puddle. That is to say, a condition that the pH test paper is kept soaked in the test solution is maintained. As a result, the drying speed of the pH test paper becomes surprising slow. Hence, even an inexperienced person who performs the test for the first time can easily and reliably measure the accurate pH value calmly and slowly.

As the material for mounting papers for bonding the pH test paper thereon, neutral water-repelling thick paper or plastic that is white and does not dissolve in water, and is neither acidic nor alkaline is preferably used. The bonding region of the pH test paper to be attached on the mounting paper is preferably either one region of the front edge, the central portion and the rear edge of the pH test paper, or two places of the front edge and the rear edge. Moreover, the bonding means of the pH test paper is not particularly limited, and a neutral insoluble adhesive may be used, the test paper and the mounting paper may be stitched up with a thread, the pH test paper may be latched on the mounting paper by a clip or a stapler, or the front edge of the test paper may be welded on the mounting paper using a wax.

### BRIEF DESCRIPTION OF THE DRAWINGS

The features, objects and advantages of the present invention will become more apparent from the following detailed description in connection with the accompanying drawings in which:

FIG. 1 is a plan view showing a first example of a pH test stick according to the present invention;

FIG. 2 is a plan view showing the implemented state of FIG. 1;

FIG. 3 is a side elevation schematically showing the operation in the example shown in FIG. 1;

FIG. 4 is a plan view showing a second example of a pH test stick according to the present invention;

FIG. 5 is a plan view showing a third example of a pH test stick according to the present invention;

FIG. 6 is a plan view showing a fourth example of a pH test stick according to the present invention; and

FIG. 7 is a plan view showing a fifth example of a pH test stick according to the present invention.

### DETAILED DESCRIPTION OF THE PREFERRED EMBODIMENT

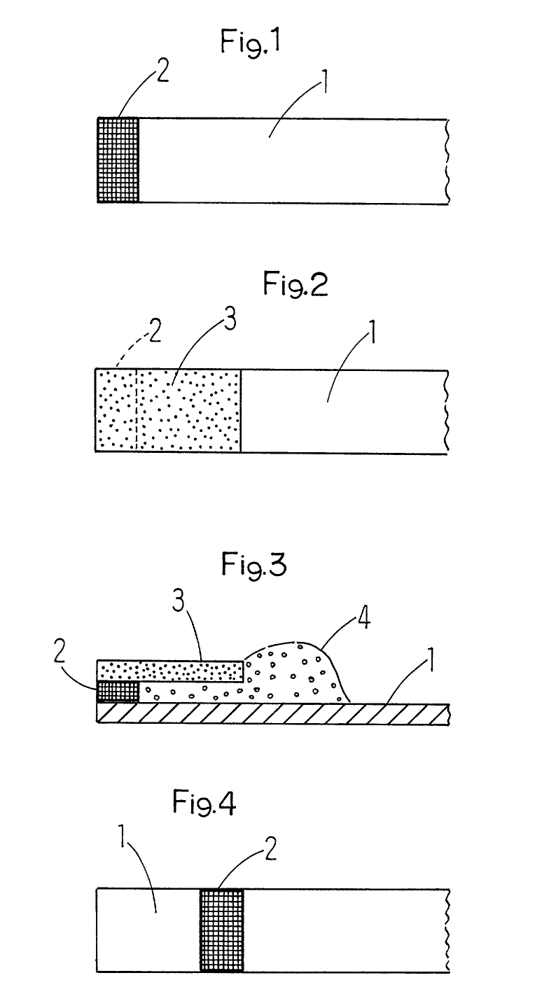

The examples will now be described with reference to the accompanying drawings. FIG. 1 and FIG. 2 are plan views showing a first example of a pH test stick of the present invention, and FIG. 3 is a side elevation schematically showing the operation thereof. In the first example, only the front edge of the pH test paper 3 is bonded on a mounting paper 1 by an adhesive 2. That is to say, as shown in FIG. 1, the adhesive 2 is provided at the tip of the slender water-repelling mounting paper 1 having a width of about 5 to 10 mm. The width of the adhesive 2 for a margin for paste is preferably about 1 to 2 mm. FIG. 2 shows a state in which the front edge of the pH test paper 3 having a length of about 10 to 20 mm is bonded on the adhesive 2. When a test solution such as urine is poured on the thus constructed pH test stick, the test solution 4 flows into between the pH test paper 3 and the mounting paper 1 in the unbonded separated portion, as shown schematically in FIG. 3, and the excessive test solution is accumulated in the vicinity of the rear edge of the pH test paper 3. As the water content intensely evaporates from the surface of the pH test paper 3, this accumulated test solution 4 continuously dampens the pH test paper 3 all the time, due to a capillary phenomenon of cellulose fiber in a filter paper, serving as the base material of the pH test paper. As a result, drying-out of the pH test paper pasted on the mounting paper 1 is significantly delayed.

FIG. 4 is a plan view showing a second example of a pH test stick of the present invention. In this example, an adhesive 2 is provided at 15 mm rearwards from the point of the mounting paper 1, so that only the rear edge of the pH test paper is partially bonded. In this manner, when a test solution such as urine is poured on the pH test stick, it can be prevented that the pH test paper is turned over due to the power of the urine. Moreover, when the pH test stick onto which the test solution is poured is inclined upwards, the test solution flowed into the gap between the pH test paper and the mounting paper can be prevented from running down along the mounting paper. As a result, the effect of delaying drying-out of the pH test paper is doubled.

FIG. 5 is a plan view showing a third example of a pH test stick of the present invention. In this example, the adhesive 2, 2′ is provided in two places, at the point and at the rear of the mounting paper 1, so that the front edge and the rear edge of the pH test paper are bonded thereto. In this manner, even if the pH test stick is inclined upwards or downwards, overspill of the test solution flowed into the gap between the pH test paper and the mounting paper can be prevented. As a result, drying-out of the pH test paper is further delayed and the color tone at the initial stage of color development is kept for a long time.

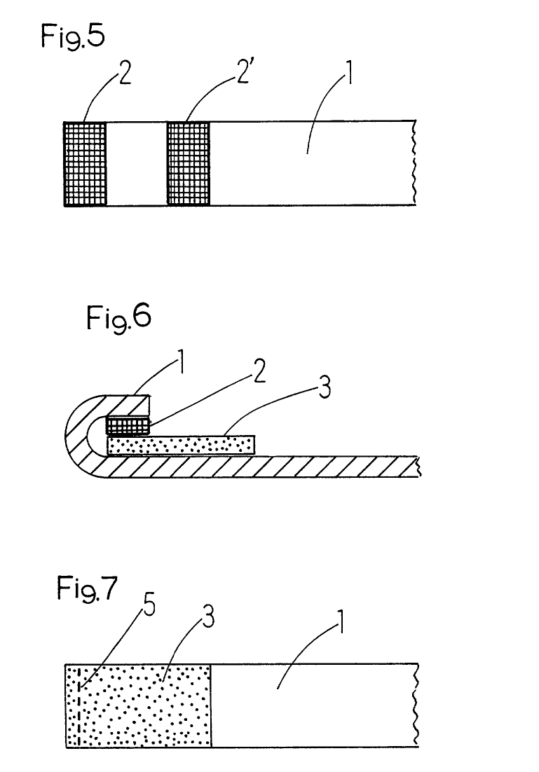

FIG. 6 is a plan view showing a fourth example of a pH test stick of the present invention. In this example, the margin for paste is formed by folding the point of the mounting paper 1. The adhesive 2 is provided in this margin for paste, to bond the front edge of the pH test paper 3 thereto, thereby the drop of water coming down along the mounting paper 1 wraps the whole surface of the pH test paper 3. As a result, drying-out of the pH test paper is considerably delayed.

FIG. 7 is a plan view showing a fifth example of a pH test stick of the present invention. In this example, instead of providing an adhesive at the point of the mounting paper 1, the pH test paper 3 is stitched up with a thread.

As is obvious from the above description, with the pH test stick of the present invention, since the pH test paper is partially bonded to the mounting paper of the stick, the pH test paper in the separated portion where the test paper is not bonded to the mounting paper, can be continuously damped with the test solution from the backside. In this manner, drying-out of the pH test paper is considerably delayed, thereby the initial vivid color tone developed by the test solution soaked in the pH test stick is kept for a long time. As a result, the developed color can be slowly compared with the color in the calorimetric table, without worrying about the change in the color tone with the advance of drying-out. Hence, even an inexperienced person who performs the pH test for the first time can measure the pH value easily and reliably.

What is claimed is:

1. A pH test stick, wherein by partially bonding the pH test paper to a water-repelling mounting paper, a gap is formed between a separated portion of the pH test paper and the mounting paper, so that a test solution flows into this gap.
